(19) United States
(12) Patent Application Publication
(10) Pub. No.: US 2017/0180745 A1
(43) Pub. Date: Jun. 22, 2017

(54) Prediction method and Electronic Apparatus of encoding mode of variable resolution

(71) Applicants: Le Holdings (Beijing) Co., Ltd., Beijing (CN); LeCloud Computing Co., Ltd., Beijing (CN)

(72) Inventor: Maosheng Bai, Beijing (CN)

(21) Appl. No.: 15/246,684

(22) Filed: Aug. 25, 2016

Related U.S. Application Data
(63) Continuation of application No. PCT/CN2016/088715, filed on Jul. 5, 2016.

(30) Foreign Application Priority Data
Dec. 18, 2015 (CN) 201510959338.4

(51) Int. Cl. H04N 19/40; H04N 19/132; H04N 19/59; H04N 19/105; H04N 19/159

(52) U.S. Cl. CPC H04N 19/40; H04N 19/105; H04N 19/159; H04N 19/59; H04N 19/132; H04N 19/184

(57) ABSTRACT

Disclosed are a prediction method and electronic apparatus of encoding mode of variable resolution. Decode a current input bit stream and obtain bit stream information during decoding, wherein the bit stream information includes frame type of a current frame to be decoded and macro-block coding information; predict frame type of a frame to be transcoded corresponding to the input bit stream according to the bit stream information and predict coding information of the frame to be transcoded according to the mapping relationship between the resolution of the input bit stream and a target resolution of transcoding. The quality of transcoding is assured while the transcoding time is saved.

### CROSS REFERENCE TO RELATED APPLICATIONS

This application is a continuation of International Application No. PCT/CN2016/088715, filed on Jul. 5, 2016, which is based upon and claims priority to Chinese Patent Application No. 2015109593384, filed on Dec. 18, 2015, the entire contents of which are incorporated herein by reference.

### TECHNICAL FIELD

The present disclosure relates to the video technology field, more particularly to a prediction method and electronic apparatus of encoding mode of variable resolution.

### BACKGROUND

With the popularization of 4K televisions and the increase of household bandwidth, the demand for high quality live videos is also increasing. The 4K television is a television of a 4K resolution. The 4K resolution is a resolution standard of new digital movies and digital content, and gains this name because of its horizontal resolution of about 4,000 pixels, which has a slight deviation in different applied fields. The 4K resolution can provide more than 880 million pixels, which provides the display quality of nearly ten million pixels that achieves the quality of cinematic images, and it is equivalently more than four times the current top resolution of 1080p as its fineness of display is more than four times that of 1080p.

Of course, the price of ultra HD is pretty high. The amount of data per frame in the 4K display is usually up to 50 MB, so the decoding for play or editing needs a machine with a top-level configuration. In order to adequately consider the experiences of live broadcasting given to the audience using different bandwidths, the existing technology provides the fluent play of a video under different bandwidths by usually transcoding the video into several bit streams of different qualities and different levels. However, real-time transcoding causes a great deal of resource consumption of the code converter.

Therefore, there is a need to develop a high quality real-time transcoding method of variable video resolution as the complexity of coding is efficiently reduced.

### SUMMARY

An embodiment of the present disclosure provides a prediction method and electronic apparatus of encoding mode of variable resolution to resolve the deficiency in the art that real-time transcoding causes a great deal of resource consumption of the code converter, and to achieve high quality real-time transcoding of variable resolution as the complexity of coding is efficiently reduced.

In the first aspect, an embodiment of the present disclosure provides a prediction method of encoding mode of variable resolution, including:
decoding a current input bit stream, and obtaining bit stream information during decoding, wherein the bit stream information comprises a frame type of a current frame to be decoded and macro-block coding information;
predicting a frame type of a frame to be transcoded corresponding to the input bit stream according to the bit stream information, and predicting coding information of the frame to be transcoded according to a mapping relationship between a resolution of the input bit stream and a target resolution of transcoding.

In the second aspect, an embodiment of the present disclosure provides a non-volatile computer storage medium storing computer-executable instructions that are configured to perform the aforementioned prediction method of encoding mode of variable resolution.

In the third aspect, an embodiment of the present disclosure provides an electronic apparatus, including:
at least one processor; and,
a memory for communicating with the at least one processor; wherein,
the memory stores instructions executable by the at least one processor, and when executed by the at least one processor, the instructions controlling the at least one processor to perform the aforementioned prediction method of encoding mode of variable resolution.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a technical flow chart of the Embodiment 1 of the present disclosure;

FIG. 2 is a technical flow chart of the Embodiment 2 of the present disclosure;

FIG. 3 is a technical flow chart of the Embodiment 3 of the present disclosure;

FIG. 4 is another technical flow chart of the Embodiment 3 of the present disclosure;

FIG. 5 is a schematic view of motion vector direction of a candidate reference block in the Embodiment 3 of the present disclosure;

FIG. 6 is a schematic structural diagram of an electronic apparatus in the Embodiment 4 of the present disclosure;

FIG. 7 is a schematic structural diagram of an apparatus in the Embodiment 6 of the present disclosure.

### DETAILED DESCRIPTION

The main idea of the present disclosure is automatically detecting the intensity of noises in a video, and dynamically performing video denoising according to the noise intensity of the video; and retaining image data of low frequency in each video frame as much as possible after the denoising function is accomplished by two air layers.

The present disclosure will be described in further detail with reference to some embodiment and the attached drawings, so that the object, solution and advantages will become more apparent. In a typical configuration, a computing device includes one or more processors or central processing units (CPUs), input/output interfaces, network interfaces, and memories.

The memory may include non-permanent memory, random access memory (RAM) and/or nonvolatile memory, e.g., read-only memory (ROM) or flash memory (flash RAM) as used in a computer readable medium. The memory can be regarded as an example of a computer readable medium.

The computer readable medium includes permanent and non-permanent as well as removable and non-removable media capable of accomplishing a purpose of information storage by any method or technique. The term of information may be referred to as computer executable instructions, a data structure, a program module or any kind of data. Examples of the computer storage medium may include, but are not limited to, phase-change memory (PRAM), static random-access memory (SRAM), dynamic random access memory (DRAM), other types of random access memory (RAM), read-only memory (ROM), electrically-erasable programmable read-only memory (EEPROM), flash memory or any other memory technologies, compact disc read-only memory (CD-ROM), digital versatile disk (DVD) or any other optical storage media, cassette tape, diskette or any other magnetic storage device, or any other non-transmission medium which can be used to store information and accessed by the computing device. As defined herein, the computer readable medium does not include transitory medium such as a modulated data signal and a carrier wave.

Certain terms are used throughout the following descriptions and claims to refer to particular components. As one skilled in the art will appreciate, hardware manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to.” “Substantially” means that those skilled in the art, within an acceptable error range, can solve said problems within a certain error range, and basically achieve said technical effects. Moreover, the terms “couple” and “coupled” are intended to mean either an indirect or a direct electrical connection. Thus, if a first device couples to a second device, that connection may be through a direct electrical connection, or through an indirect electrical connection via other devices and connections. The following detailed description is of the best currently contemplated modes of carrying out the invention. However, the description is not to be taken in a limiting sense, but is made merely for the purpose of illustrating the general principles of the invention. The scope of the invention is best defined by the appended claims.

It also needs to be explained that the term “comprising”, “including” or any other variation thereof is intended to cover a non-exclusive inclusion, such that a product or a system comprising/including a series of elements not only comprises/includes those elements, but also comprises/includes other elements not expressly listed, or further comprises/includes elements inherent for such a product or system. In the absence of more restrictions, an element defined by the statement “comprising/including a . . . ” does not exclude the existence of additional identical elements in the product or system comprising/including the element.

Embodiments of the present invention are applied to a real-time transcoding system of 4K variable resolution, and as compared to the related art where macro-blocks obtained during decoding are directly encoded according to a target resolution of transcoding during the transcoding process, the technical core of embodiments of the present invention is decoding an original input bit stream to obtain bit stream information of the input bit stream, and predicting coding information of an output bit stream of a different resolution according to the bit stream information during transcoding, so as to carry out fast, efficient coding.

### Embodiment 1

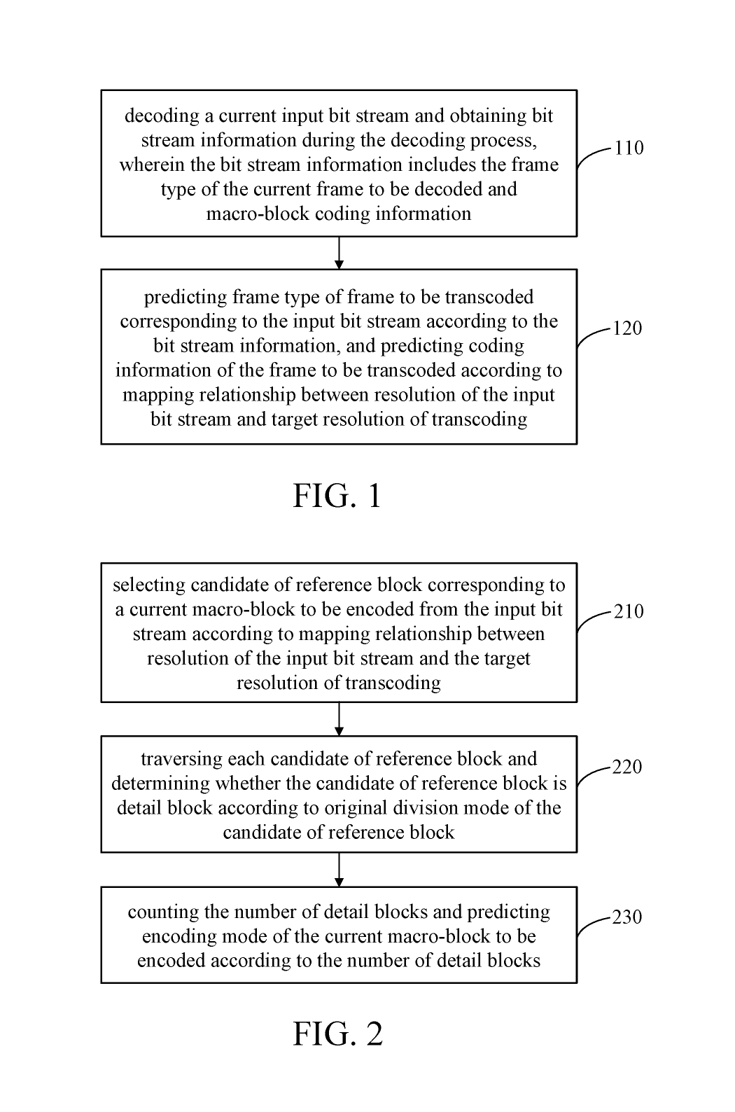

FIG. 1 is a technical flow chart of the Embodiment 1 of the present disclosure, and combined with FIG. 1, a prediction method of encoding mode of variable resolution in an embodiment of the present disclosure mainly includes two great steps:
Step 110: decoding a current input bit stream and obtaining bit stream information during decoding, wherein the bit stream information includes the frame type of the current frame to be decoded and macro-block coding information;
during the operation of the transcoding system, video frames obtained by decoding an input 4K bit stream are encoded. The core of an embodiment of the present disclosure is obtaining original coding information of the input bit stream and performing the inheritance of coding information according to this original coding information before frames obtained in the decoding process are encoded, so as to implement the prediction of coding information for the follow-up high quality coding.

In an embodiment of the present disclosure, the default setting of coding is H264 video coding. Frame types of the input bit stream include intra prediction coding frame (I_FRAME), forward prediction coding frame (P_FRAME) and bi-directional interpolated prediction frame (B_FRAME).

Data is transmitted in a network via each frame as a small unit. A frame is constituted by several parts, different parts executes different functions. A frame is a still image, a sequence of frames constitutes moving picture, such as TV images and so on.

A variety of algorithms can be used in a particular compression fro reducing data size, wherein IPB is the most common way. I-frame is an intra prediction coding frame belonging to intra-frame compression, which only needs frame data during I decoding (because only depending on the coding information of neighboring macro-blocks).

P-frame is a forward prediction coding frame belonging to inter-frame coding. P-frame presents the difference between this frame and a previous reference frame, and prediction data obtained by forward motion compensation as well as residual data is used to reconstruct a current P-frame.

B-frame is a bi-directional deviation frame, which records the difference between a current frame and a previous reference frame and the difference between the current frame and a next reference frame (also known as forward reference frame). Decoding needs not only the previous reference frame but also the forward reference frame, so as to reconstitute the current B-frame by the prediction data obtained in the forward-backward motion compensation, and residual data.

In an embodiment of the present disclosure, the macro-block coding information includes the encoding mode, reference frame and motion vector of each macro-block in an original input bit stream, so the follow-up coding achieves efficient coding prediction according to these coding information in combination with the mapping relationship between the original resolution and resolution of target transcoding for variable resolution transcoding.

Step 120: predicting frame type of a frame to be transcoded corresponding to the input bit stream according to the bit stream information, and predicting coding information of the frame to be transcoded according to mapping relationship between resolution of the input bit stream and target resolution of transcoding.

In an embodiment of the present disclosure, the target resolution can be 1080P, 720P or the like; the two things use the same prediction method. In a particular prediction of encoding mode, a candidate reference block corresponding to a current macro-block to be encoded is selected from the input bit stream according to the mapping relationship between resolution of the input bit stream and the target resolution of transcoding, and then the encoding mode of the current macro-block to be encoded is predicted according to the original encoding mode of the candidate reference block.

If the currently-coded frame is an intra prediction coding frame and when intra macro-block of the intra prediction coding frame is encoded, each candidate reference block is traversed and whether the candidate reference block is a detail block is determined according to original division mode of the candidate reference block; then, the number of detail blocks is counted and encoding mode of the current macro-block to be encoded is predicted according to the number of detail blocks.

If the currently-coded frame is a bi-directional interpolated prediction frame, each candidate reference block is traversed and whether the candidate reference block is an inter-frame prediction block or an intra-frame prediction block is determined when the bi-directional interpolated prediction frame is encoded; if the currently-coded frame is the intra-frame prediction block, whether the intra-frame prediction block is a detail block is determined and the number of detail blocks is counted; if the currently-coded frame is the inter-frame prediction block, the number of inter-frame prediction blocks is counted and encoding mode of the current macro-block to be encoded is predicted according to the number of detail blocks and the number of intra-frame prediction blocks.

In this embodiment, obtaining the coding information of a source bit stream is made during the transcoding process, so as to predict the encoding mode of an object to be encoded. Therefore, to a certain extent, coding time can be saved, the efficiency of coding can be enhanced, the technical cost of transcoding can be decreased; and meanwhile, it is assured that the present disclosure has the same video quality as full encoding mode.

### Embodiment 2

FIG. 2 is a technical flow chart of the Embodiment 2 of the present disclosure, and the Embodiment 2 illustrates an implement to predict intra-frame coding information in a n embodiment of the present disclosure, and mainly includes the following steps:

Step 210: selecting candidate reference block corresponding to a current macro-block to be encoded from the input bit stream according to mapping relationship between resolution of the input bit stream and the target resolution of transcoding;

The physical resolution of 4K television is up to 3840*2160 that is 4 times the resolution of FHD.1920*1080 and is 9 times the resolution of HD.1280*720. For real-time transcoding, results of subjecting the same content to the coding conditions of different bit rates or resolutions have many similarities therebetween, so the coding information of a source bit stream can be reused. Therefore, when a 4K bit stream is transcoded from 2160P to 1080P and 720P, the reference block corresponding to the current macro-block to be encoded in 2160P is greatly valuable.

In a case of 1080P coding, resolution mapping of 4K to 1080P is 1:2, that is, a block corresponding to a current 1080P (0,0) block is constituted by 4K (0,0), (0,1), (1,0), (1,1). Therefore, the prediction mode of the current macro-block to be encoded needs to be selected from the above 4 candidates of reference block. In an embodiment of the present disclosure, rounding the resolution mapping is made by a related resolution mapping relationship to select 4 candidates of reference block if the resolution mapping is not an integer during downward resolution transcoding.

Step 220: traversing each candidate reference block and determining, according to original division mode of the candidate reference block, whether the candidate reference block is detail block;
recording the candidate reference block to be a detail block if the division mode of the candidate reference block is I_8×8 or I_4×4.

Step 230: counting the number of detail blocks and predicting encoding mode of the current macro-block to be encoded according to the number of detail blocks.

If the number of detail blocks is smaller than or equal to 1, the prediction of the encoding mode of the current macro-block to be encoded is marked by I_16×16;
if the number of detail blocks is larger than or equal to 2, the prediction of the encoding mode of the current macro-block to be encoded is marked by I_4×4;
if the number of detail blocks does not meet the above two conditions, the prediction of the encoding mode of the current macro-block to be encoded is marked by I_8×8.

In this embodiment, predicting the coding information of transcoding is made by reusing the coding information of the source bit stream so that the coding information of the source bit stream is legitimately used to enhance the efficiency of transcoding; and meanwhile, selecting a candidate reference block for the current macro-block to be encoded and determining whether the candidate reference block is a detail block are made according to the mapping relationship between the input bit stream and the output bit stream so that image details obtained in video transcoding are greatly protected to enhance the quality of transcoding. Therefore, users can obtain better visual experiences.

### Embodiment 3

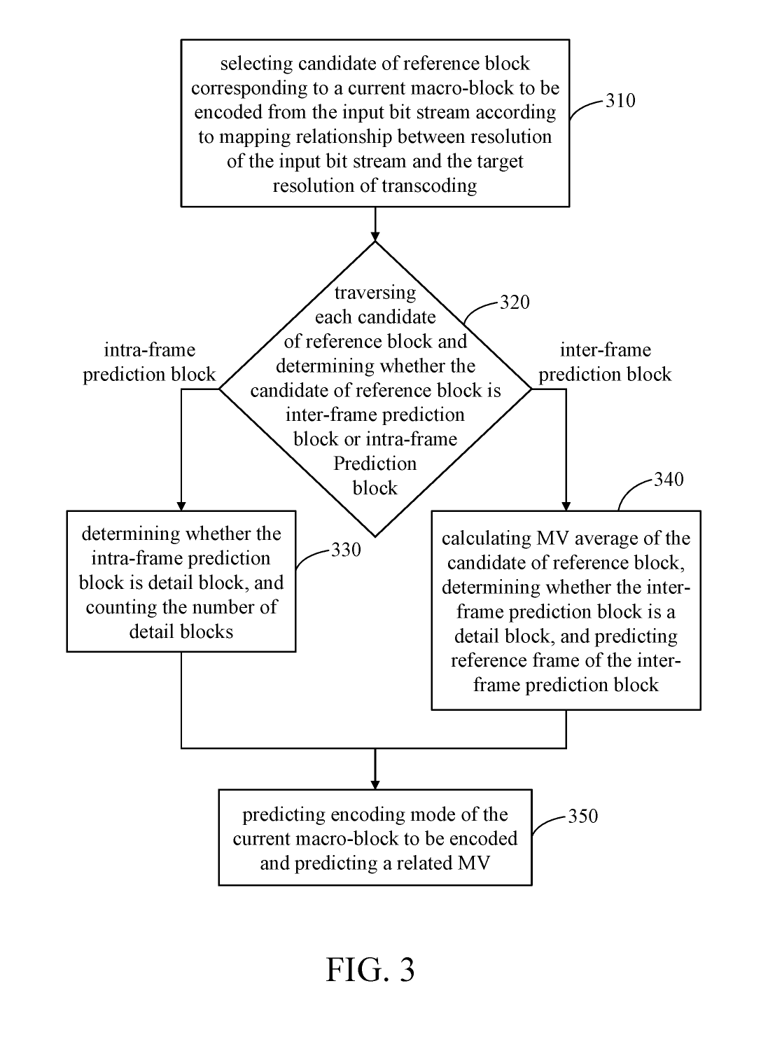

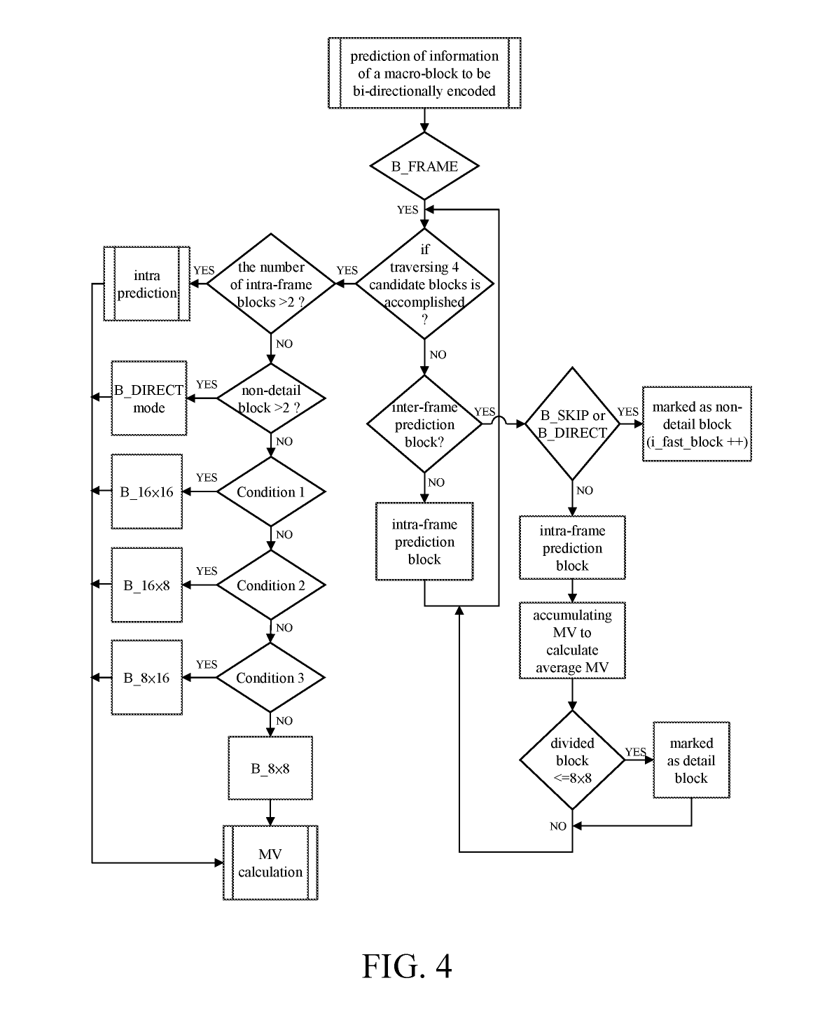

FIG. 3 is a technical flow chart of the Embodiment 3 of the present disclosure, and the Embodiment 3 exemplarily illustrates an implement to predict the coding information of bi-directional interpolated prediction frames in an embodiment of the present disclosure. FIG. 4 presents the detailed parts of FIG. 3. Combining with FIG. 3 and FIG. 4, the Embodiment 3 of the present disclosure mainly includes the following steps:

Step 310: selecting candidate reference block corresponding to a current macro-block to be encoded from the input bit stream according to mapping relationship between resolution of the input bit stream and the target resolution of transcoding;

This step has the same executive process as step 210. When an input bit stream of a 2160P resolution is transcoded into an output bit stream of 1080P, 4 candidates of reference block are selected for the current macro-block to be encoded. Similarly, when an input bit stream of a 2160P resolution is transcoded into an output bit stream of 720P, 4 nearby candidates of reference block are selected for the current macro-block to be encoded. Hereafter, embodiments of the present disclosure are described based on 4 candidates of reference block.

Step 320: traversing each candidate reference block and determining whether the candidate reference block is inter-frame prediction block or intra-frame prediction block; performing step 330 if the candidate reference block is an intra-frame prediction block; performing step 340 if the candidate reference block is an inter-frame prediction block.
Step 330: determining whether the intra-frame prediction block is detail block, and counting the number of detail blocks;
parameter i_intra++ if it is an intra-frame prediction block, and obtaining the amount of the intra according to the value of the parameter i_intra after all the candidates of reference block are traversed.
Step 340: calculating MV average of the candidate reference block, determining whether the inter-frame prediction block is a detail block, and predicting reference frame of the inter-frame prediction block;

Since P-frame uses a mixed mode of previous reference frame coding and intra coding and graphic objects shown in a dynamic image's neighboring frames have a certain correlation there between, during inter-frame prediction coding, a dynamic image can be divided into some blocks or macro-blocks, and it is tired to find out the position of each block or macro-block in the neighboring frames and then obtain relative offset between the space positions of the two frames. This relative offset is usually referred to as motion vector, and the process to obtain a motion vector is referred to as motion estimation. The prediction deviation obtained in motion matching and the motion vector are sent to the decoding end, and the decoding end finds relative blocks or macro-blocks in the neighboring decoded reference frames according to the positions indicated by the motion vector, and adds up the relative blocks or macro-blocks and the prediction deviation to obtain the positions of these blocks or macro-blocks in the current frame.

Motion vectors corresponding to positional macro-blocks of the original input bit stream have high availability, so the motion vector (MV) of the input bit stream is used as a reference for predicting the follow-up movement in an embodiment of the present disclosure.

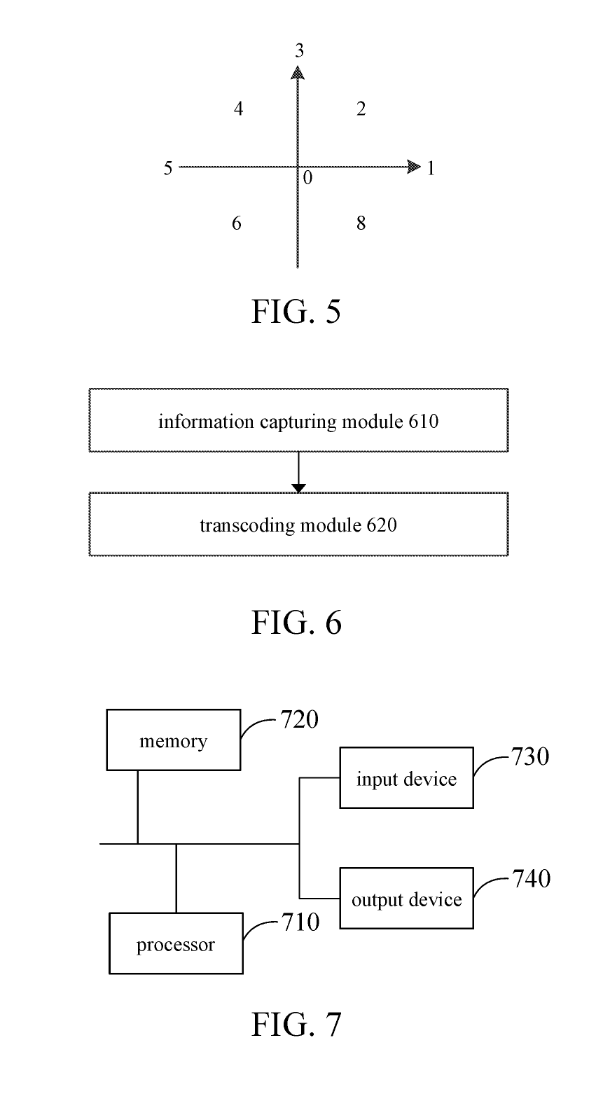

As shown in FIG. 5, in the exemplary case of outputting 1080P, determining the direction of MV of a candidate reference block is made. In the figure, 0˜8 are directions of 9 reference MVs; and in 1080P, MV direction of MV(0,0) is 0, and MV direction of MV(−1,1) is 8. The direction of the current candidate reference block is marked by mb_candinate[i]→direction (i is a serial number of a candidate reference block and ranges from 0 to 3 in 1080P). After MV of each candidate reference block is obtained, the accumulation of the value of MV and the calculation of average MV are made for the follow-up prediction of MV. After the average MV is obtained, determining original division mode of the candidate reference block is made, and if the number of divided blocks is smaller than or equal to 8×8, the candidate reference block is recorded as a detail block.

In this step, it is further made to determine whether the current macro-block to be encoded is B_SKIP or B_DIRECT; if yes, the current macro-block to be encoded is recorded as a non-detail block with a parameter i_fastblock++.

In an embodiment of the present disclosure, the prediction of whether the current macro-block to be encoded uses a previous reference frame or a forward reference frame is made according to the previous reference frame and forward reference frame used by each candidate reference block. The previous reference frame is recorded as parameter i_ref0, the forward reference frame is recorded as parameter i_ref1. If the number of previous reference frames of the candidate reference block is larger than 1, iref0++ is recorded, and if the number of forward reference frames of the candidate reference block is larger than 1, i_ref1++ is recorded. After four candidates of reference block are traversed and determined, the prediction of whether the current macro-block to be encoded uses a previous reference frame or a forward reference frame is made according to the accumulated values of i_ref0 and i_ref1.

Step 350: predicting encoding mode of the current macro-block to be encoded and predicting a related MV.

In this step, firstly, three conditions, Condition 1, Condition 2 and Condition 3, are defined for the direction of a current candidate reference block and are respectively expressed as follows:

(mb_candinate[1]→direction−mb_candinate[0]→direction)<=1&&(mb_candinate[2]→direction−mb_candinate[0]→direction)<=1&&(mb_candinate[3]→direction−mb_candinate[0]→direction)<=1 Condition 1

(mb_candinate[1]→direction−mb_candinate[0]→direction)<=1&&(mb_candinate[3]→direction−mb_candinate[2]→direction)<=1&&(mb_candinate[3]→direction−mb_candinate[1]→direction)>1∥(mb_candinate[3]→direction−mb_candinate[1]→direction)>1 Condition 2

(mb_candinate[2]→direction−mb_candinate[0]→direction)<=1&&(mb_candinate[3]→direction−mb_candinate[1]→direction)<=1&&(mb_candinate[3]→direction−mb_candinate[2]→direction)>1 Condition 3

wherein the direction of the current candidate reference block is mb_candinate[i]→direction, i represents a serial number of the candidate reference block, i ranges from 0 to 3, && represents “AND” in logic operations, ∥ represents “OR” in logic operations.

After all the candidates of reference block are traversed in step 320, the following 5 determinations are made:
Determination A: the number of intra-frame prediction blocks is larger than 2, [symbol] encoding the current macro-block to be encoded according to the intra-frame prediction block and performing the coding information prediction in the Embodiment 2 according to the number of detail blocks counted.
Determination B: predicting that encoding mode of the current macro-block to be encoded is B_DIRECT mode when the number of non-detail blocks is larger than 2; Determination C: predicting that encoding mode of the current macro-block to be encoded is B_16×16 if MV of the current candidate reference block meets the Condition 1;
Determination D: predicting that encoding mode of the current macro-block to be encoded is B_16×8 if MV of the current candidate reference block meets the Condition 2;
Determination E: predicting that encoding mode of the current macro-block to be encoded is B_8×16 if the current candidate reference block n MV meets the Condition 3;
Determination F: predicting that encoding mode of the current macro-block to be encoded is B_8×8 if the current candidate reference block does not meet any of the above Determinations A˜E.

After possible encoding mode of the current macro-block to be encoded is determined, a respective reference MV corresponding to each mode is calculated.

For the B_16×16 encoding mode, the motion vector MV is calculated by the following Equation 1:

Mv[x]=(mvc[0]·x+mvc[1]·x+mvc[2]·x+mvc[3]·x)>>2)/scale_x

Mv[y]=(mvc[0]·y+mvc[1]·y+mvc[2]·y+mvc[3]·y)>>2)/scale_y

Scale_x=round(source_x/dest_x);

Scale_y=round(source_y/dest_y); Equation 1

In the Equation 1, Mv/[x] represents the motion vector in x direction; Mv[y] represents the motion vector in y direction;
mvc[0]˜mvc[3] represent MVs corresponding to 4 candidates of reference block; mvc[0]·x˜mvc[3]·x represent MVs corresponding to 4 candidates of reference block in x direction; mvc[0]·y˜mvc[3]·y represent MVs corresponding to 4 candidates of reference block in y direction;
(mvc[0]·x+mvc[1]·x+mvc[2]·x+mvc[3]·x)>>2 represents the motion vector of the average MV in x direction calculated in step 340;
(mvc[0]·y+mvc[1]·y+mvc[2]·y+mvc[3]·y)>>2 represents the motion vector of the average MV in y direction calculated in step 340;
source_x, source_y respectively represent resolutions of an input bit stream in x, y directions;
dest_x, dest_y respectively represent resolutions in target x, y directions; Scale_x, Scale_y represent transition parameters in x, y directions for the follow-up calculation; round( ) indicates that the function return rounds the value to the nearest integer according to the number of indicated bits; >> represents a right shift operator.

For the B_16×8 encoding mode, the motion vector MV is calculated by the following Equation 2:

Mv[0][x]=(mvc[0]·x+mvc[1]·x)>>1)/scale_x

Mv[0][y]=(mvc[1]·y+mvc[1]·y)>>1)/scale_y

Mv[1][x]=(mvc[2]·x+mvc[3]·x)>>1)/scale_x

Mv[1][y]=(mvc[2]·y+mvc[3]·y)>>1)/scale_y Equation 2

For the B_8×16 encoding mode, the motion vector MV is calculated by the following Equation 3:

Mv[0][x]=(mvc[2]·x+mvc[0]·x)>>1)/scale_x

Mv[0][y]=(mvc[2]·y+mvc[0]·y)>>1)/scale_y

Mv[1][x]=(mvc[1]·x+mvc[3]·x)>>1)/scale_x

Mv[1][y]=(mvc[1]·y+mvc[3]·y)>>1)/scale_y Equation 3

One 16×16 macro-block is constituted by two 16×8 blocks, Mv [0] and Mv[1] respectively represent motion vectors of two 16×8; Mv[0][x] represents MV of Mv[0] in x direction; Mv[0][y] represents MV of Mv[0] in y direction.

In an embodiment of the present disclosure, P-frame does not need any backward prediction block, its prediction mode is similar to that of B-frame, and there are no more related descriptions hereafter.

In this embodiment, predicting the encoding mode of an object to be encoded is made by reusing the coding information of the source bit stream. Therefore, to a certain extent, coding time can be saved; and meanwhile, this embodiment simply optimizes the prediction mode to assure that the present disclosure has the same video quality as full encoding mode.

### Embodiment 4

FIG. 6 is a schematic structural diagram of a device in the Embodiment 4 of the present disclosure, and combining with FIG. 6, a prediction device of encoding mode of variable resolution in an embodiment of the present disclosure includes the following modules: information capturing module 610, transcoding module 620.

The information capturing module 610 is configured to decode current input bit stream and obtain bit stream information during decoding, wherein the bit stream information comprises frame type of current frame to be decoded and macro-block coding information;

The transcoding module 620 is configured to predict frame type of frame to be transcoded corresponding to the input bit stream according to the bit stream information and predict coding information of the frame to be transcoded according to mapping relationship between resolution of the input bit stream and target resolution of transcoding.

Particularly, the transcoding module 620 is further configured to: set frame type corresponding to the input bit stream to be the frame type of frame to be transcoded when video coding format is H264, wherein the frame types comprises intra prediction coding frame, forward prediction coding frame and bi-directional interpolated prediction frame.

Particularly, the transcoding module 620 is further configured to: select candidate reference block corresponding to current macro-block to be encoded from the input bit stream according to mapping relationship between resolution of the input bit stream and the target resolution of transcoding, and predict encoding mode of the current macro-block to be encoded according to original encoding mode of the candidate reference block.

Particularly, the transcoding module 620 is further configured to: traverse each candidate reference block and determine whether the candidate reference block is detail block according to original division mode of the candidate reference block when intra macro-block of the intra prediction coding frame is encoded; count the number of detail blocks and predict encoding mode of the current macro-block to be encoded according to the number of detail blocks.

Particularly, the transcoding module 620 is further configured to: traverse each candidate reference block and determine whether the candidate reference block is inter-frame prediction block or intra-frame prediction block when the bi-directional interpolated prediction frame is encoded; determine whether the intra-frame prediction block is detail block and count the number of detail blocks if the candidate reference block is the intra-frame prediction block; count the number of inter-frame prediction blocks and predict encoding mode of the current macro-block to be encoded according to the number of detail blocks and the number of intra-frame prediction blocks if the candidate reference block is the inter-frame prediction block.

The device corresponding to FIG. 6 executes the embodiments shown in FIG. 1˜FIG. 5; and its steps and technical effect can be referred to the embodiments shown in FIG. 1˜FIG. 5, and there are no more related description hereafter.

The described apparatus embodiment is merely exemplary. The units described as separate parts may or may not be physically separate, and parts displayed as units may or may not be physical units, that is, may be located in one position, or may be distributed on a plurality of network units. A part or all of the modules may be selected according to actual needs to achieve the objectives of the solutions of the embodiments. A person of ordinary skill in the art may understand and implement the technical solution without creative works.

### Embodiment 5

The Embodiment 5 provides a non-volatile computer storage medium, and the computer storage medium stores computer-executable instructions that can perform the prediction method of encoding mode of variable resolution in any of the above embodiments.

### Embodiment 6

FIG. 7 is a diagram of the hardware structure of an electronic apparatus of performing the prediction method of encoding mode of variable resolution in the Embodiment 6 of the disclosure, and the apparatus as shown in FIG. 7 includes:
one or more processors 710 and a memory 720, and FIG. 6 exemplarily presenting one processor 710.

The apparatus of performing the prediction method of encoding mode of variable resolution further includes: an input device 730 and an output device 740.

The processor 710, the memory 720, the input device 730 and the output device 740 can be connected via a bus or other connection manners, and FIG. 7 exemplarily illustrates the use of bus for connections.

The memory 720 as a non-volatile computer-readable storage medium can be configured to store a non-volatile software program, non-volatile computer-executable program and module, such as program instructions/module corresponding to the prediction method of encoding mode of variable resolution in this embodiment (e.g. the information capturing module 610, the transcoding module 620 as shown in FIG. 6). The processor 710 executes a variety of function disclosures and the data process of the electronic apparatus by running the non-volatile software program, instructions and module stored in the memory 720, to carry out the prediction method of encoding mode of variable resolution in the above method embodiments.

The memory 720 can include a program storage area and a data storage area, wherein the program storage area can store an operating system and disclosure program required for at least one function; the data storage area can store the data created according to the use of a processing device operating according to items in the list. Moreover, the memory 720 can include a high speed random-access storage, and further include a non-volatile storage, such as at least one disk storage member, at least one flash memory member and other non-volatile solid state memory member. In some embodiments, the memory 720 can be selected from memories having a remote connection with the processor 710, and these remote memories can be connected to an electronic apparatus of predicting encoding mode of variable resolution. The aforementioned network includes, but not limited to, internet, intranet, local area network, mobile communication network and combination thereof.

The input device 730 can receive digital or character information, and generate a key signal input corresponding to the user setting and the function control of an electronic apparatus of predicting encoding mode of variable resolution. The output device 740 can include a display apparatus such as a screen.

The one or more modules are stored in the memory 720, and the one or more modules execute the prediction method of encoding mode of variable resolution in any of the above method embodiments when executed by the one or more processors 710.

The aforementioned product can execute the method in the embodiments, and has functional modules and beneficial effect corresponding to the execution of the method. The technical details not described in the embodiments can be referred to the method provided in the embodiments of the disclosure.

The electronic apparatus in the embodiments of the present disclosure is presence in many forms, and the electronic apparatus includes, but not limited to:

(1) mobile communication apparatus: characteristics of this type of device are having the mobile communication function, and providing the voice and the data communications as the main goal. This type of terminals include: smart phones (e.g. iPhone), multimedia phones, feature phones, and low-end mobile phones, etc.

(2) ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4) server: an apparatus provide computing service, the composition of the server includes processor, hard drive, memory, system bus, etc, the structure of the server is similar to the conventional computer, but providing a highly reliable service is required, therefore, the requirements on the processing ability, stability, reliability, security, scalability, manageability, etc. are higher.

(5) other electronic apparatus having a data exchange function.

The described device embodiment is merely exemplary. The units described as separate parts may or may not be physically separate, and parts displayed as units may or may not be physical units, that is, may be located in one position, or may be distributed on a plurality of network units. A part or all of the modules may be selected according to actual needs to achieve the objectives of the solutions of the embodiments.

With the description of the above embodiments, those skilled in the art can understand clearly that, the methods according to the above embodiments can be implemented by means of software plus a general-purpose hardware platform, and of course can be implemented by hardware. Based on such understanding, the aforementioned technical solutions essentially or a part of the technical solutions which makes contribution to the related art can be embodied in a form of a software product, and the computer software product is stored in a computer readable storage medium, such as a ROM/RAM, a magnetic disc, an optical disk or the like, and includes some instructions to cause a computer apparatus which may be a personal computer, a server, network equipment, or the like to implement the method or a part of the method according to the respective embodiments.

Finally, it should be noted that the foregoing embodiments are merely intended for describing the technical solutions of the disclosure rather than limiting the disclosure. Although the disclosure is described in detail with reference to the foregoing embodiments, persons of ordinary skill in the art should understand that they may still make modifications to the technical solutions recorded in the foregoing embodiments or make equivalent replacements to part of technical features of the technical solutions recorded in the foregoing embodiments; however, these modifications or replacements do not make the essence of the corresponding technical solutions depart from the spirit and scope of the technical solutions of the embodiments of the disclosure.

What is claimed is:

1. A prediction method of encoding mode of variable resolution, applied to a terminal comprising:
decoding a current input bit stream, and obtaining bit stream information during decoding, wherein the bit stream information comprises a frame type of a current frame to be decoded and macro-block coding information;
predicting a frame type of a frame to be transcoded corresponding to the input bit stream according to the bit stream information, and predicting coding information of the frame to be transcoded according to a mapping relationship between a resolution of the input bit stream and a target resolution of transcoding.

2. The method according to claim 1, wherein predicting the frame type of the frame to be transcoded related the input bit stream according to the bit stream information further comprises:
setting a frame type corresponding to the input bit stream to be the frame type of the frame to be transcoded if a video coding format is H264, wherein the frame types comprise an intra prediction coding frame, a forward prediction coding frame and a bi-directional interpolated prediction frame.

3. The method according to claim 2, wherein predicting the coding information of the frame to be transcoded according to the mapping relationship between the resolution of the input bit stream and the target resolution of transcoding further comprises:
selecting a candidate reference block corresponding to a current macro-block to be encoded from the input bit stream according to the mapping relationship between the resolution of the input bit stream and the target resolution of transcoding, and predicting an encoding mode of the current macro-block to be encoded according to an original encoding mode of the candidate reference block.

4. The method according to claim 3, wherein predicting the encoding mode of the current macro-block to be encoded according to the original encoding mode of the candidate reference block further comprises:
traversing each candidate reference block and determining, according to an original division mode of the candidate reference block, whether the candidate reference block is a detail block when an intra macro-block of the intra prediction coding frame is encoded;
counting the number of detail blocks and predicting the encoding mode of the current macro-block to be encoded according to the number of detail blocks.

5. The method according to claim 3, wherein predicting the encoding mode of the current macro-block to be encoded according to the original encoding mode of the candidate reference block further comprises:
traversing each candidate reference block and determining whether the candidate reference block is an inter-frame prediction block or an intra-frame prediction block when the bi-directional interpolated prediction frame is encoded;
determining whether the intra-frame prediction block is a detail block, and counting the number of detail blocks, if the candidate reference block is the intra-frame prediction block; if the candidate reference block is the inter-frame prediction block, counting the number of inter-frame prediction blocks and predicting the encoding mode of the current macro-block to be encoded according to the number of detail blocks and the number of intra-frame prediction blocks.

6. A non-volatile computer storage medium storing computer-executable instructions that are configured to:
decode a current input bit stream, and obtain bit stream information during decoding, wherein the bit stream information comprises a frame type of a current frame to be decoded and macro-block coding information;
predict a frame type of a frame to be transcoded corresponding to the input bit stream according to the bit stream information, and predict coding information of the frame to be transcoded according to a mapping relationship between a resolution of the input bit stream and a target resolution of transcoding.

7. An electronic apparatus, comprising:
at least one processor; and,
a memory for communicating with the at least one processor; wherein,
the memory stores instructions executable by the at least one processor, and when executed by the at least one processor, the instructions controlling the at least one processor to:
decode a current input bit stream, and obtain bit stream information during decoding, wherein the bit stream information comprises a frame type of a current frame to be decoded and macro-block coding information;
predict a frame type of a frame to be transcoded corresponding to the input bit stream according to the bit stream information, and predict coding information of the frame to be transcoded according to a mapping relationship between a resolution of the input bit stream and a target resolution of transcoding.

8. The non-volatile computer storage medium according to claim 6, wherein predicting a frame type of a frame to be transcoded corresponding to the input bit stream according to the bit stream information further comprising:
setting a frame type corresponding to the input bit stream to be the frame type of the frame to be transcoded if a video coding format is H264, wherein the frame types comprise an intra prediction coding frame, a forward prediction coding frame and a bi-directional interpolated prediction frame.

9. The non-volatile computer storage medium according to claim 8, wherein predicting coding information of the frame to be transcoded according to a mapping relationship between a resolution of the input bit stream and a target resolution of transcoding further comprising:
selecting a candidate reference block corresponding to a current macro-block to be encoded from the input bit stream according to the mapping relationship between the resolution of the input bit stream and the target resolution of transcoding, and predicting an encoding mode of the current macro-block to be encoded according to an original encoding mode of the candidate reference block.

10. The non-volatile computer storage medium according to claim 9, wherein predicting an encoding mode of the current macro-block to be encoded according to an original encoding mode of the candidate reference block further comprises:
traversing each candidate reference block and determining, according to an original division mode of the candidate reference block, whether the candidate reference block is a detail block when an intra macro-block of the intra prediction coding frame is encoded;
counting the number of detail blocks and predicting the encoding mode of the current macro-block to be encoded according to the number of detail blocks.

11. The non-volatile computer storage medium according to claim 9, wherein predicting the encoding mode of the current macro-block to be encoded according to the original encoding mode of the candidate reference block further comprises:
traversing each candidate reference block and determining whether the candidate reference block is an inter-frame prediction block or an intra-frame prediction block when the bi-directional interpolated prediction frame is encoded;
determining whether the intra-frame prediction block is a detail block, and counting the number of detail blocks, if the candidate reference block is the intra-frame prediction block; if the candidate reference block is the inter-frame prediction block, counting the number of inter-frame prediction blocks and predicting the encoding mode of the current macro-block to be encoded according to the number of detail blocks and the number of intra-frame prediction blocks.

12. The electronic apparatus according to claim 7, wherein predicting a frame type of a frame to be transcoded corresponding to the input bit stream according to the bit stream information further comprising:
setting a frame type corresponding to the input bit stream to be the frame type of the frame to be transcoded if a video coding format is H264, wherein the frame types comprise an intra prediction coding frame, a forward prediction coding frame and a bi-directional interpolated prediction frame.

13. The electronic apparatus according to claim 12, wherein predicting coding information of the frame to be transcoded according to a mapping relationship between a resolution of the input bit stream and a target resolution of transcoding further comprising:
selecting a candidate reference block corresponding to a current macro-block to be encoded from the input bit stream according to the mapping relationship between the resolution of the input bit stream and the target resolution of transcoding, and predicting an encoding mode of the current macro-block to be encoded according to an original encoding mode of the candidate reference block.

14. The electronic apparatus according to claim 13, wherein predicting an encoding mode of the current macro-block to be encoded according to an original encoding mode of the candidate reference block further comprises:
traversing each candidate reference block and determining, according to an original division mode of the candidate reference block, whether the candidate reference block is a detail block when an intra macro-block of the intra prediction coding frame is encoded;
counting the number of detail blocks and predicting the encoding mode of the current macro-block to be encoded according to the number of detail blocks.

15. The electronic apparatus according to claim 13, wherein predicting the encoding mode of the current macro-block to be encoded according to the original encoding mode of the candidate reference block further comprises:
traversing each candidate reference block and determining whether the candidate reference block is an inter-frame prediction block or an intra-frame prediction block when the bi-directional interpolated prediction frame is encoded;
determining whether the intra-frame prediction block is a detail block, and counting the number of detail blocks, if the candidate reference block is the intra-frame prediction block; if the candidate reference block is the inter-frame prediction block, counting the number of inter-frame prediction blocks and predicting the encoding mode of the current macro-block to be encoded according to the number of detail blocks and the number of intra-frame prediction blocks,
candidate reference block candidate reference block candidate reference block candidate reference block candidate reference block candidate reference block candidate reference block candidate reference block candidate reference block
